(19) United States
(12) Patent Application Publication
(10) Pub. No.: US 2007/0049346 A1
(43) Pub. Date: Mar. 1, 2007

(54) Antenna distribution system

(75) Inventors: Paul Brite, Coral Springs, FL (US); Jeffrey Brite, Wantagh, NY (US)

Correspondence Address: SCULLY SCOTT MURPHY & PRESSER, PC, 400 GARDEN CITY PLAZA, SUITE 300, GARDEN CITY, NY, 11530, US

(73) Assignee: PJB TECHNOLOGIES, LLC, Wantagh, NY (US)

(21) Appl. No.: 11/214,186

(22) Filed: Aug. 29, 2005

(51) Int. Cl. H04M 1/00

(52) U.S. Cl. 455/562.1

(57) ABSTRACT

An antenna distribution system used to facilitate transmission and reception of wireless communications within demised premises (indoors). The antenna distribution system includes a ceiling grid having an antenna element formed integral with or attached to the ceiling grid. The antenna is operably coupled to a wireless communications network. The antenna(s) are connected to one or more transceivers. The antenna can transmit and receive any type of wireless signal.

### FIELD OF INVENTION

This invention relates to an antenna distribution system that is used to facilitate transmission and reception for wireless communications. More particularly, the invention relates to an antenna means attached to or formed integrally with a ceiling grid where the ceiling grid acts as a structural element to support and route the antenna means.

### BACKGROUND

Indoor high-speed wireless communications have become widely used for both voice and data applications in many different types of organizations such as universities, hospitals, government agencies, emergency services and corporations.

A typical wireless communications system includes a plurality of wireless base stations, wireless terminal devices, and antennas. The wireless terminal devices communicate with the wireless base stations.

The wireless base stations are arranged to cover a plurality of areas within demised premises (indoor space). They are typically deployed in an elevated location, i.e., attached to a ceiling, to obtain the best coverage within the premises. Each base station has a specified range or radial distance that encompasses a coverage area (or cell) within a specific base station that can communicate with wireless terminals currently occupying the cell.

However, indoor wireless communications present several challenges for the placement of these wireless components. As such, the placement of an antenna becomes extremely important for the wireless system to function properly. This placement dependency varies with the frequency and power of transmission but in general is characterized by inadequate coverage of the cells creating “dead zones” within the demised premises, signal fading due to propagation anomalies of wireless signals including loss of line-of-sight and multiple reflections off physical objects, walls, ceilings. In addition the movement of people within the demised premises and the simultaneous transmission/reception of wireless communications from their wireless terminal units can create congestion for access (leading to transport delays or blocking).

Several wireless systems have tried to address these problems by placing a plurality of antennas spaced apart either on the walls or the ceiling of the demised premises. The plurality of antennas or antenna array collectively provide the coverage and capacity required to support wireless communications within the demised premises.

For example, United States Patent Application Publication No. 2004/0189910 (hereinafter “Matsushita”) discloses a leaky coaxial cable deployed above a ceiling as an antenna for wireless base stations. The leaky cable is arranged to meander on the ceiling of the indoor space. The antenna creates a propagation path between wireless base stations and a plurality of wireless terminal units located in the indoor area. Matsushita teaches that the cable can run across the front and the rear parts of the showcase or ceiling tiles.

There still is a need to provide wireless antennas that can be easily installed and fabricated without having a separate cable meandering on a ceiling. Therefore, it is an object of the invention to provide an antenna distribution means that can be used for any wireless communication that solves the propagation problems and takes advantage of the structural features of a ceiling to support and route the antenna system.

### BRIEF SUMMARY OF THE INVENTION

One aspect of the invention includes an antenna distribution system used to facilitate the transmission and reception of wireless communications signals within demised premises (indoors). An antenna distribution system is used to physically deploy one or more antenna means throughout the demised premises.

The antenna distribution system comprises a ceiling grid with an antenna means attached to the ceiling grid. This attachment can be on at least one side of the ceiling grid. The antenna means can be also attached to the top of the ceiling grid. The antenna means can be attached to the ceiling grid using any known attachment means. Such attachment can occur during the fabrication of the ceiling grid. Alternatively, the antenna means is formed integrally with the ceiling grid. The antenna is embedded in the ceiling grid during fabrication. Alternatively, the antenna means can be attached to the bottom of the ceiling grid.

The antenna means are physically connected to at least one transceiver and the antenna means and transceiver constitutes at least a portion of a wireless base station. The complete wireless communications system includes at least one wireless base station that communicates with one or more wireless terminal units.

The wireless base station includes at least one antenna means and a transceiver.

The antenna means can be any transmit/reception element device capable of radiating or detecting electromagnetic energy at various frequencies, such as a radiating coaxial cable or a fractional wavelength stub.

The antenna means acts as a transmit/receive element for wireless communications between at least one wireless terminal and at least one wireless base station that forms a backbone structure of a wireless network.

Any number of antenna elements can be used to facilitate transmission and reception of wireless signals. A single antenna can support a single transceiver or a single antenna can support a plurality of transceivers. Additionally, a single transceiver can be connected to multiple antennas.

The transceiver(s) connected to the antenna means by cables may be physically co-located with the individual antenna above the ceiling or may be remotely housed (up to several hundred feet away in a telecommunications closet.)

The wireless network can operate at different frequencies, including, but not limited to Wifi bands.

The ceiling grid can be any ceiling grid that physically supports a plurality of ceiling tiles, such as a T-bar grid and can be fabricated using any known pliable material.

The transceiver(s) coupled to the antenna array, which collectively act as the wireless base station(s), are capable of transmitting a radio frequency identification signal acting as RFID reader(s). The radio frequency identification signal (response) is generated by a radio frequency identification (RFID) tag (active or passive).

In another aspect of the invention, a wireless communication system is disclosed. The wireless communication system comprises a ceiling grid and an antenna distribution system with an antenna means to function as an antenna for wireless communication signal propagation. The antenna means is used in conjunction with the ceiling grid and facilitates the transmission and reception of wireless signals. The wireless communication system further includes a wireless transmission device for transmitting the wireless signal through the transmission path and a wireless reception device for receiving the wireless signal from the transmission path.

### BRIEF DESCRIPTION OF THE DRAWINGS

These and other features, benefits, and advantages of the present invention will become apparent by reference to the following text figures, with like reference numbers referring to like structures across the views, wherein:

FIG. 1 illustrates an antenna distribution system according to the first embodiment of the invention.

FIG. 2 illustrates a detailed view of the antenna element attached to the main tee and coupled to the interconnecting cable according to the first embodiment of the invention.

FIGS. 3a-3c illustrate examples of an antenna array and transceiver configurations according to the invention.

FIG. 4 illustrates an alternate configuration for the interconnecting cable and antenna element of the antenna distribution system according to the first embodiment of the invention.

FIG. 4a illustrates another alternate configuration for the interconnecting cable and antenna element of the antenna distribution system according to the first embodiment of the invention.

FIG. 5 illustrates a third alternate configuration for the interconnecting cable and antenna element of the antenna distribution system according to the first embodiment on the invention.

FIG. 6 illustrates an antenna distribution system according to a second embodiment of the invention.

FIG. 7 illustrates an alternate configuration for the attachment of a coaxial cable of the antenna distribution system according to the second embodiment of the invention.

FIG. 8 illustrates another alternate configuration for the coaxial cable of the antenna distribution system according to the second embodiment of the invention.

FIG. 9 illustrates a third alternate configuration for the coaxial cable of the antenna distribution system according to the second embodiment of the invention.

FIG. 10 is an example of a wireless communication system using the antenna distribution system according to any of the embodiments of the invention.

FIG. 11 illustrates another alternate configuration for the interconnecting cable and antenna element of the antenna distribution system according to the first embodiment of the invention.

FIG. 12 illustrates another alternate configuration for the coaxial cable of the antenna distribution system according to the second embodiment of the invention.

### DETAILED DESCRIPTION OF THE INVENTION

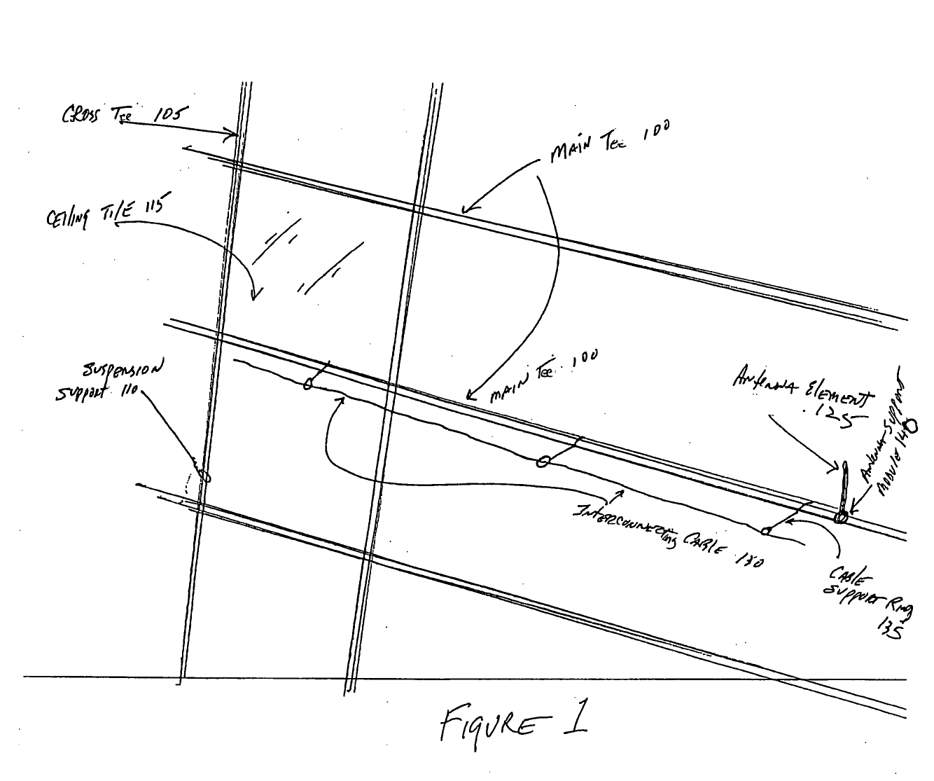

FIG. 1 depicts an antenna distribution system according to the first embodiment of the invention. Specifically, as shown in FIG. 1, the antenna distribution system is used in conjunction with a standard drop ceiling. The drop ceiling includes a main beam or tee 100 (hereinafter “main tee”), a plurality of cross beams or tees 105 (hereinafter “cross tees”), a plurality of suspension supports 110 for the main tee 100, and ceiling tiles 115. The main tee 100 and plurality of cross tees are attached to a ceiling grid 120. The main tee 100 and the plurality of cross tees 105 can be of any type of support grids such as a tee grid. As shown in FIGS. 1-9, the ceiling grid is a Fine Line Grid, however, an Exposed Tee Grid, Concealed Tee Grid, or a Slot Tee Grid can be used.

In the antenna distribution system, according to the first embodiment, an antenna element 125 is attached to the main tee 100. The antenna element 125 can be any device that is capable of radiating or detecting electromagnetic energy at various frequencies. For example, a fractional wavelength stub antenna, as depicted in FIG. 1 can be used. The antenna element 125 is electrically coupled to at least one transceiver (not shown in FIG. 1) via an interconnecting cable 130.

In this embodiment, the interconnecting cable 130 is arranged on the side on the main tee 100. However, the position for the interconnecting cable 130 is not limited to the side of the main tee 100, as will be described later.

The interconnecting cable 130 is attached to the main tee 100 using a plurality of cable support rings 135. As shown in FIG. 1, cable support rings 135 are built-in to the main tee 100 and are used to route interconnecting cable 130 along the path of the main tee 100. The plurality of cable support rings 135 can be inserted into a predefined slot in the main tee 100 or attached to the main tee 100 using any known attachment means. Alternatively, the cable support rings 135 can be cable hooks.

FIG. 1 illustrates the use of one interconnecting cable 130, however, any number of interconnecting cables may be used, depending on the size of the demised premises.

The antenna element 125 is attached to the main tee 100 using an antenna support module 140. In this embodiment, the antenna support module 140 is arranged on the side on the main tee 100. However, the position for the antenna support module 140 is not limited to the side of the main tee 100, as will be described later.

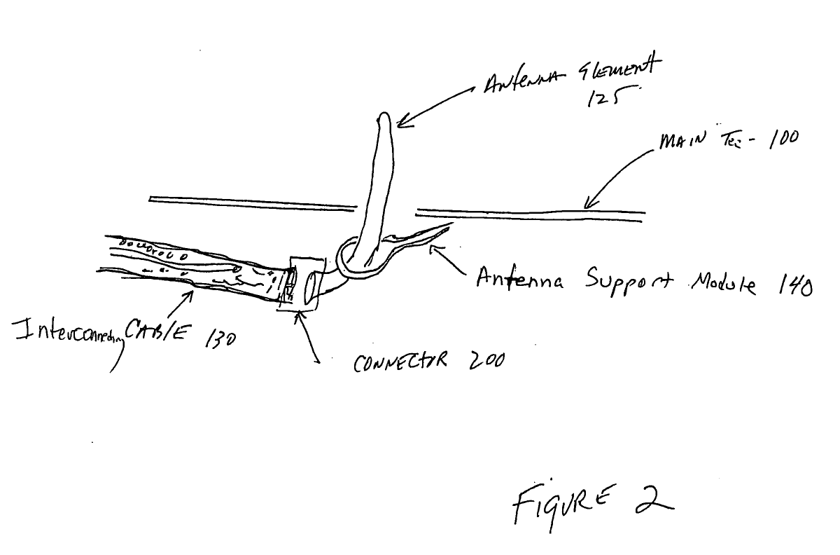

FIG. 2 illustrates a detailed view of the antenna element 125 connected with the main tee 100 and the interconnecting cable 130.

As depicted in FIG. 2 the antenna element 125 is attached to the main tee 100 with an antenna support module 140. The antenna support module 140 includes an aperture large enough for a portion of the antenna element 125 to be inserted. The other end of the antenna support module is affixed to the main tee 100. The antenna support module can be inserted into a predefined slot in the main tee 100 or attached to the main tee 100 using any known attachment means.

The antenna element 125 is also coupled to the interconnecting cable 130 using a connector 200. The connector 200 can be any type of connector such as a N-connector.

FIG. 1 illustrates the use of one antenna element 125, however, any number of antenna elements may be used to create an antenna array, depending on the size of the demised premises.

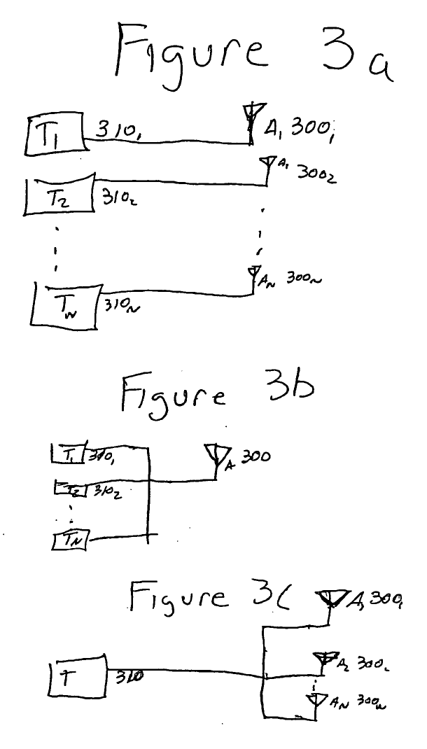

For example, any combination of the following configurations are possible for the antenna array to achieve different coverage and capacity objectives for the demised premises. As shown in FIG. 3a, an individual antenna 300 can support an individual transceiver 310, or as shown in FIG. 3b, multiple transceivers 310₁₋ₙ can also share a single antenna 300 or finally as shown in FIG. 3c, a single transceiver 310 can be connected to multiple antennas 300₁₋ₙ.

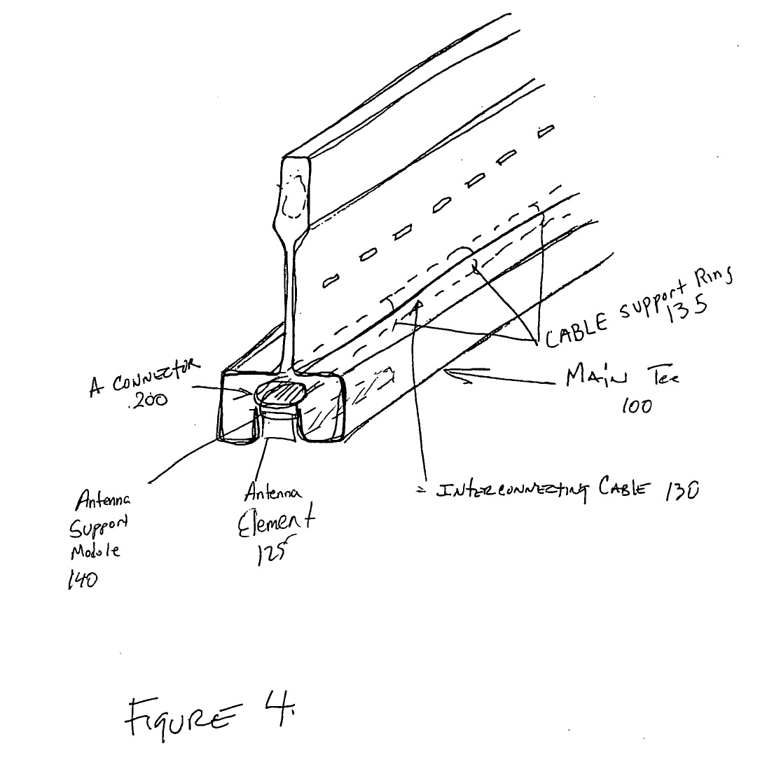

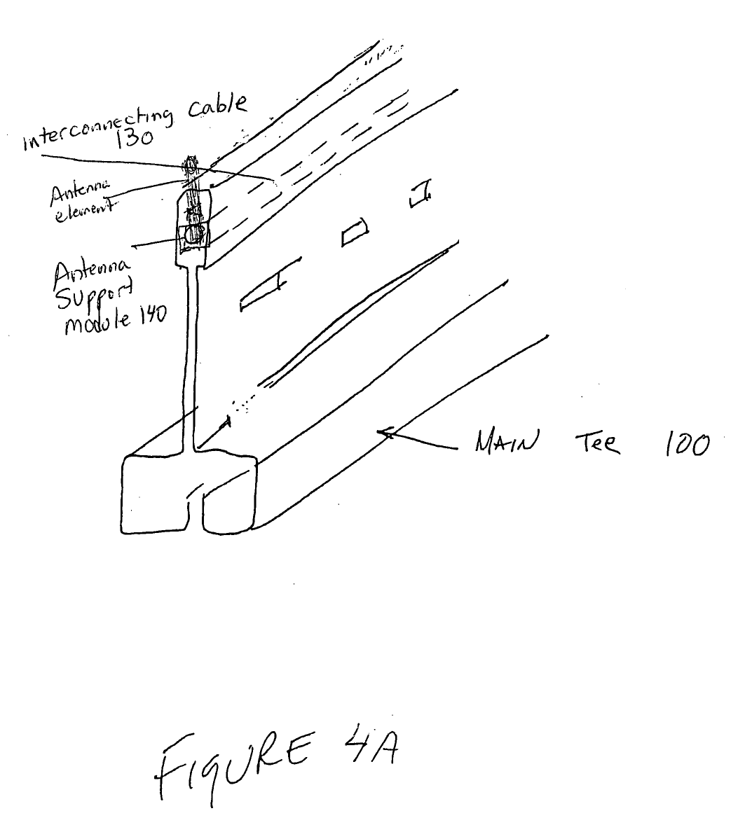

FIG. 4 depicts an alternate configuration for the antenna distribution system according to the first embodiment of the invention. For illustrative purposes only, the main tee is depicted in this Figure without the cross tees, ceiling tiles, and suspension support, as those elements are the same as disclosed in the above embodiment. Like elements are denoted with the same reference numbers.

As shown in FIG. 4, the interconnecting cable 130 is arranged in a channel that is formed from the bottom of the main tee 100. The interconnecting cable 130 is attached to this channel on the lower portion of main tee 100 using a plurality of cable support rings 135. The cable support rings 135 are attached to the main tee 100 using any known attachment means. As shown in FIG. 4, the interconnecting cable 130 is located within a predefined channel on the bottom of the main tee 100. This has the advantage that the interconnecting cable 130 is placed in an inconspicuous location and is out of the way of the suspension support cables.

Similarly, the antenna element 125 is arranged within this channel on the bottom of the main tee 100. The antenna element 125 is coupled to the interconnecting cable 130 using a connector 200. As shown in FIG. 4, the antenna element 125 is parallel to the main tee 100 and interconnecting cable 130. However, the antenna element 125 can be positioned perpendicular to the main tee 100, coupled to the interconnecting cable 130 and attached to the main tee 100 using the antenna support module 140.

FIG. 4a depicts another alternative configuration for the antenna distribution system. Similar to FIG. 4, the interconnecting cable 130 is positioned in a channel within the main tee 100. However, as shown in FIG. 4a, the interconnecting cable 130 is placed in a hollow channel on the top of the main tee 100 instead of on the bottom, as shown in FIG. 4. As shown in FIG. 4a, the antenna element 125 is coupled to the interconnecting cable 130 by a connector 200. The antenna element may also be attached to the main tee using an antenna support module 140, as depicted in FIG. 2. In this configuration there is no need for a cable support ring as the interconnecting cable is placed within a hollow cavity at the top of the main tee 100. While the antenna element 125 is shown in FIG. 4A as being perpendicular to the main tee 100, the antenna element can also be embedded into the hollow cavity or channel as well.

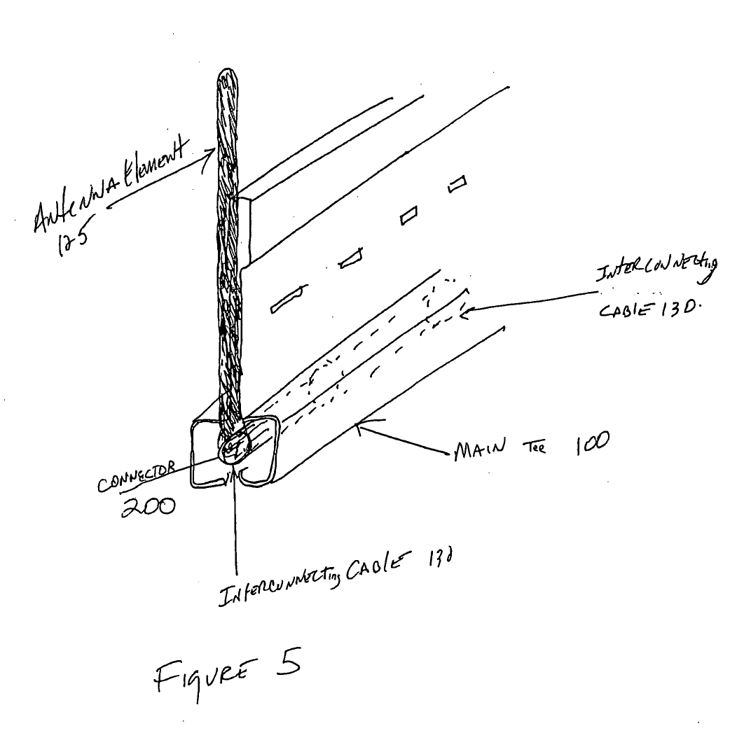

FIG. 5 depicts yet another alternate configuration of the first embodiment of the invention. For illustrative purposes only the main tee is depicted in this Figure without the cross tees, ceiling tiles, and suspension support, as those elements are the same as disclosed in the above embodiment. Like elements are denoted with the same reference numbers.

As shown in FIG. 5, the interconnecting cable 130 is embedded within the main tee 100. In this configuration the interconnecting cable 130 is fabricated in the main tee 100. This configuration has the advantage that upon installation of the main tee 100, the ceiling grid will be inherently capable of the transmission and reception of electric signals from any antenna. The antenna element 125 can be coupled to the interconnecting cable 130 after installation of the main tee 100 or coupled to the interconnecting cable 130 during the fabrication process. If the antenna element 125 is coupled to the interconnecting cable 130 during the fabrication process, the demised premises will be capable of wireless transmission upon installation of the ceiling grid with the main tee 100.

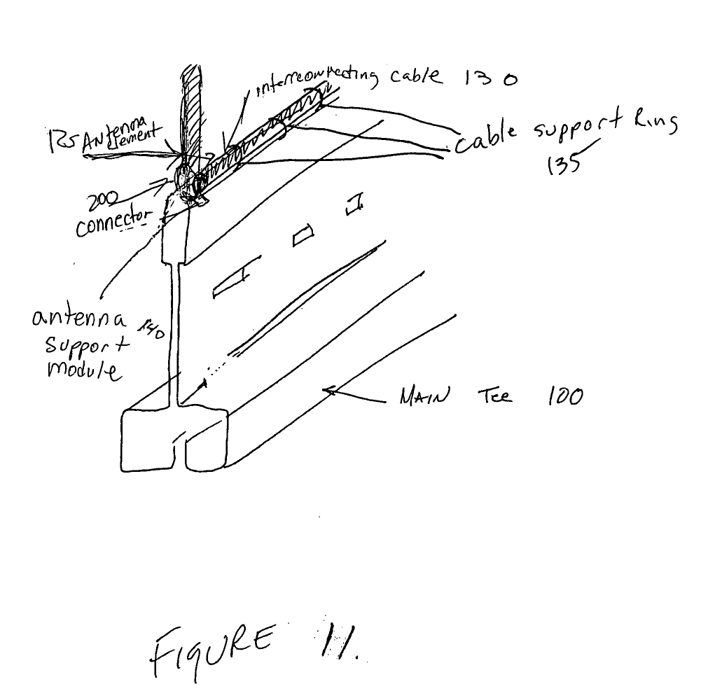

FIG. 11 depicts another alternative placement or configuration for the attachment of an antenna element 125 and interconnecting cable 130 to the main tee 100. As shown in FIG. 11, the interconnecting cable is attached to the top of the main tee 100. The interconnecting cable 130 is secured or attached to the main tee 100 using at least one cable support ring 135. Additionally and depicted in FIG. 11, the antenna element 125 is coupled to the interconnecting cable 130 using a connector 200. The antenna element 125 is attached or secured to the main tee 100 using an antenna support module 140.

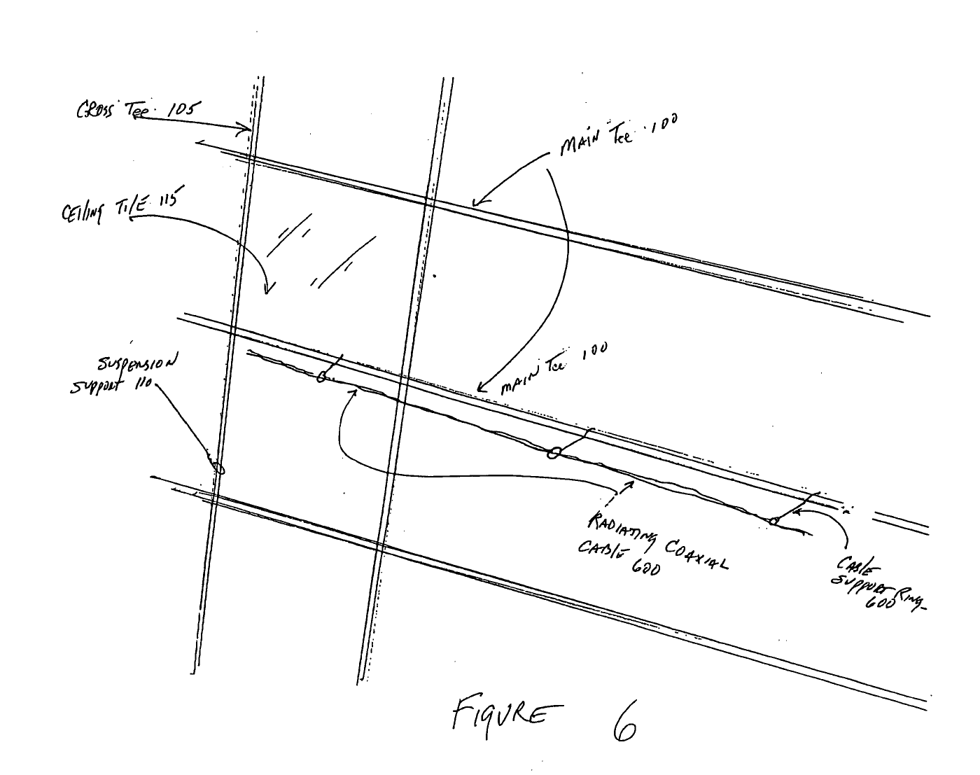

FIG. 6 depicts an antenna distribution system according to the second embodiment of the invention. The second embodiment of the invention differs from the first embodiment of the invention in that in the second embodiment does not have separate antenna element 125 and interconnecting cable 130, but includes a radiating coaxial cable 600.

As shown in FIG. 6, one or more radiating coaxial cables 600 are attached to one or more main tees 100. Each radiating coaxial cable 600 is capable of radiating or detecting electromagnetic energy at various frequencies from a transmitting source (not shown) and at least one transceiver (not shown). The radiating coaxial cable 600 is arranged within the demised premise, such that there is maximum coverage within the space.

The radiating coaxial cables 600 can be attached to the main tee 100 using a similar method as described above for the interconnecting cable 130 of the first embodiment. Specifically, the radiating coaxial cables 600 can be attached to the main tee 100 using a plurality of cable support rings 610. As shown in FIG. 6, cable support rings 610 can be built-in to the main tee 100 and are used to route radiating coaxial cables 600 along the path of the main tee 100. The plurality of cable support rings 610 can be inserted into a predefined slot in the main tee 100 or attached to the main tee 100 using any known attachment means.

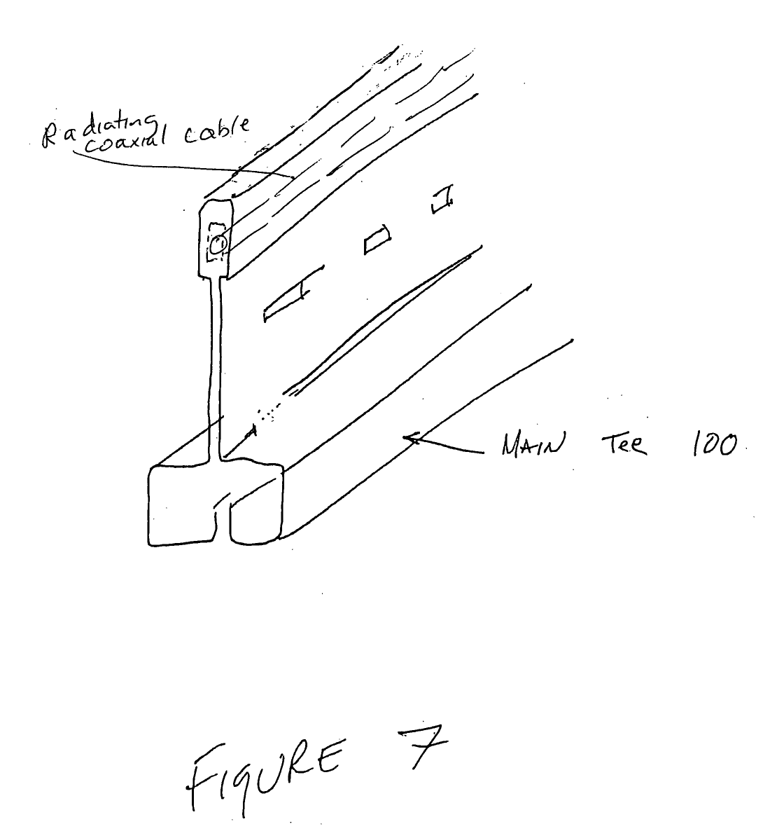

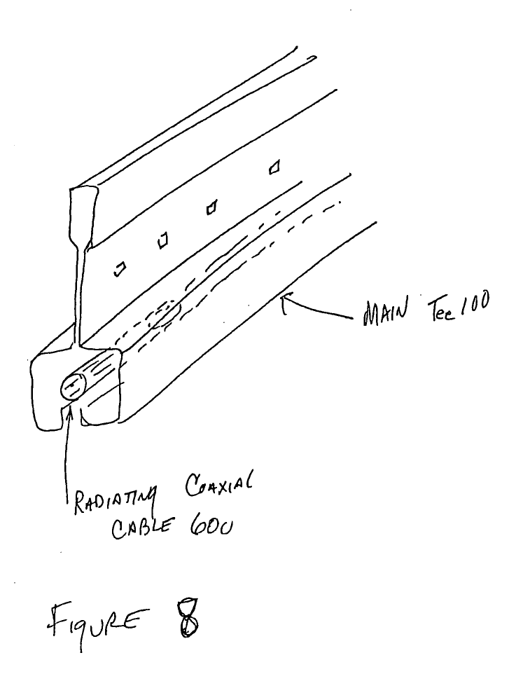

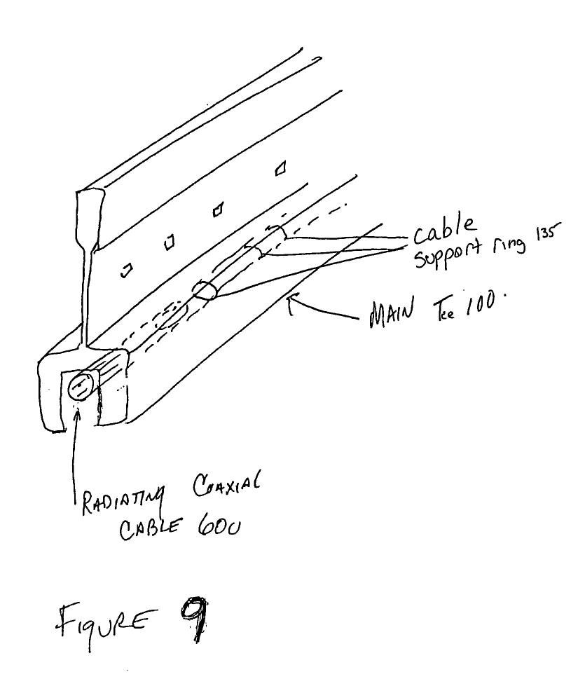

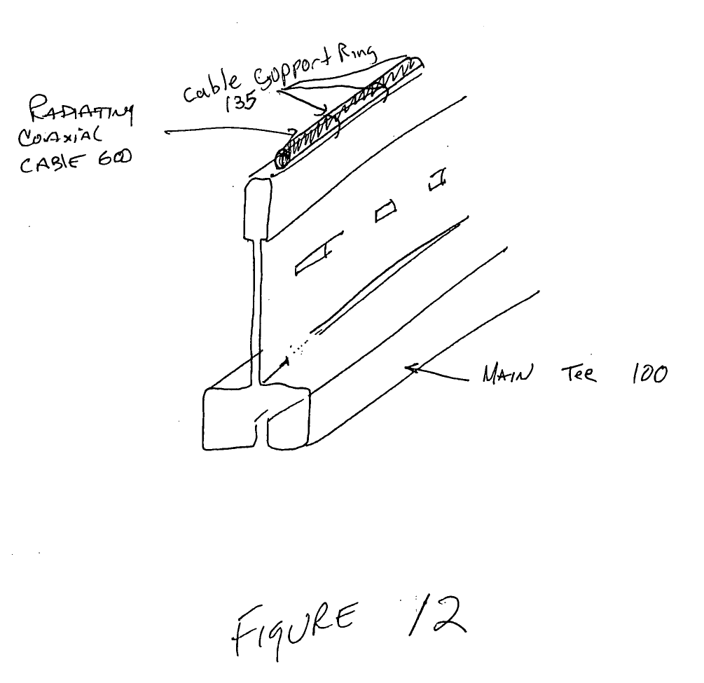

Alternatively, the radiating coaxial cable 600 can be placed within a hollow channel at the top of the main tee 100 as depicted in FIG. 7, as an alternate configuration or embedded within the main tee 100 as depicted in FIG. 8, as another alternate configuration, attached to a channel formed at the bottom of the main tee 100, as depicted in FIG. 9 or attached to the top of the main tee 100, as depicted in FIG. 12. These alternate configurations are similar to the alternate configurations for the first embodiment of the invention, as depicted in FIGS. 4, 4a, 5, and 11 and, therefore, will not be described in detail. However, since the radiating coaxial cable functions as the antenna element, there is no antenna element attached and, therefore, no need for any connection element.

In all of the disclosed embodiments and alternate configurations, the antenna element 125 or radiating coaxial cable 600 are coupled to a wireless communication network and act as a transmission path for such wireless signals. The wireless communication network includes at least one transceiver that is connected to the antenna element 125 or radiating coaxial cable 600, such transceiver is shown in FIGS. 3a-3c. Alternatively, the transceiver can be included in the housing for the antenna element 125 to create a wireless base station. The wireless base station will communicate with at least one remote wireless terminal. The remote wireless terminal can act as a wireless transmission means for generating a wireless signal. The remote wireless terminal can be any device capable of transmitting electromagnetic energy at various frequencies, including, but not limited to, radio frequencies. For example, the wireless terminal can be a radio frequency identification tag.

Additionally, the wireless terminal will be capable to transmit any signal using standard wireless protocols, including IEEE 802.11 wireless standards (such as 802.11a, b, g), Bluetooth® wireless technology, a WiFi compatible protocol, a protocol complying with a ZigBee™ wireless technology, a protocol complying with an UWB (ultra wide band) wireless technology, or others known in the art.

The wireless signal will be transmitted from the wireless terminal to a wireless receiving device at a remote location using the antenna element 125 or radiating coaxial cable 600 as a transmission path. The wireless signal can be received by the transceiver. Alternatively, the wireless signal can be relayed by the transceiver to a separate receiving device.

FIGS. 1-9, 11 and 12 illustrate exemplary placements for antenna elements and interconnecting cables, on or within a main tee such that the ceiling grid can act as a transmission path for wireless signals, however, the placements depicted in the figures are only examples.

Further, FIGS. 1-9, 11 and 12 depict the main tee 100 as a Fine Line Tee, however, the antenna element and interconnection cables can be attached, or embedded or placed within any type of ceiling grid, using any of the configurations depicted.

Additionally, the antenna element and interconnection cables are shown in FIGS. 1-9, 11, and 12 as being attached to or embedded in the main tee 100 of the ceiling grid, however, it is within the scope of the invention to attach or embed this element to cross tee 105 as well.

Furthermore, it is within the scope of the invention to insert during the fabrication process for the main tee 100 a plurality of metallic antenna elements in the ceiling grid to create an antenna array from the ceiling grid, wherein the ceiling grid itself is the antenna means and acts as a transmission path for any wireless signal.

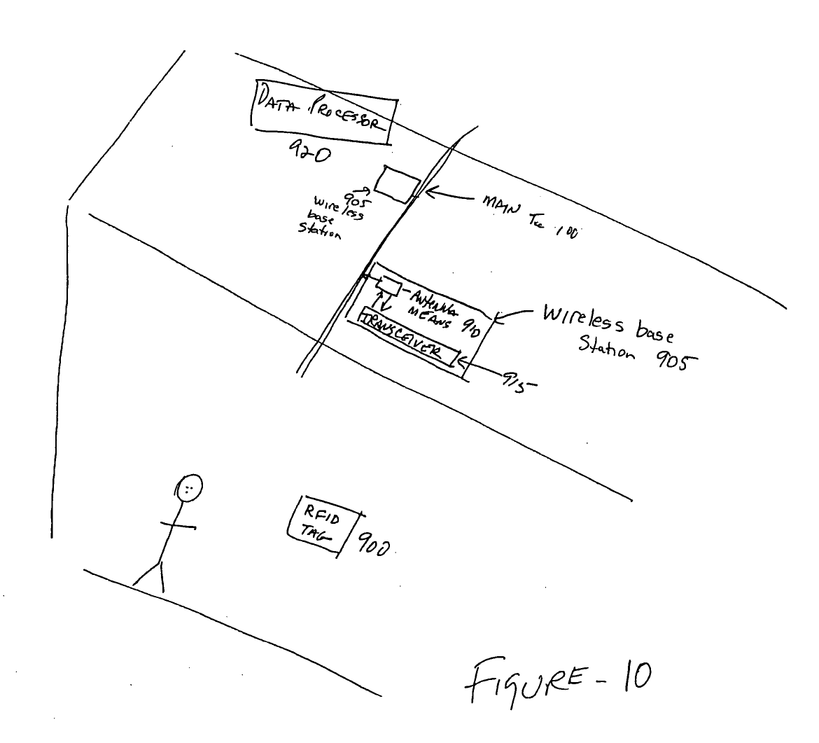

FIG. 10 is an example of a wireless communication system using the antenna distribution system according to either embodiment of the invention.

As shown in FIG. 10, the wireless terminal is a RFID tag 900. The RFID tag 900 transmits an RF signal to a data processor 920, acting as a RFID reader through at least one wireless base station 905. In FIG. 10, each wireless base station 905 includes an antenna means 910 and a transceiver 915. Each wireless base station is attached to or embedded in the main tee 100 of the ceiling grid using any of the above-identified configurations for attachment and embedding.

All of the above-identified embodiments have been described without any modification to the ceiling grid or suspension support, however, it is within the scope of the invention to modify the ceiling grid to include reinforcements to the main tees to handle the added weight of the interconnecting cables 130 and antenna element 125 and/or radiating coaxial cable 600.

The invention has been described herein with reference to particular exemplary embodiments. Certain alterations and modifications may be apparent to those skilled in the art, without departing from the scope of the invention. The exemplary embodiments are meant to be illustrative, not limiting of the scope of the invention, which is defined by the appended claims.

What is claimed is:

1. An antenna distribution system used to facilitate a transmission and reception of wireless communications within demised premises (indoors) comprising:
a ceiling grid;
an antenna means attached to said ceiling grid operably coupled to a wireless communications network; and
at least one transceiver connected to said antenna means which forms at least a wireless base station.

2. The antenna distribution system of claim 1, wherein said antenna means is coupled to said at least one transceiver by an interconnecting cable.

3. The antenna distribution system of claim 1, wherein said antenna means is attached to at least one side of said ceiling grid.

4. The antenna distribution system of claim 1, wherein said antenna means is attached to a top of said ceiling grid.

5. The antenna distribution system of claim 1, wherein said ceiling grid is a tee grid.

6. The antenna distribution system of claim 1, wherein said antenna means is a radiating coaxial cable.

7. The antenna distribution system of claim 1, wherein said antenna means is a fractional wavelength stub.

8. The antenna distribution system of claim 1, wherein said wireless communications operates at WiFi frequencies and said wireless communications network is a WiFi network.

9. The antenna distribution system of claim 1, wherein said antenna means is connected to transceivers to facilitate wireless communication between at least one end terminal, said base station to form said wireless network.

10. The antenna distribution system of claim 1, wherein said wireless communication signal is a radio frequency identification (RFID) signal.

11. The antenna distribution system of claim 10, wherein said radio frequency identification signal is generated by a radio frequency identification tag and said radio frequency identification signal is received by said antenna means to said at least wireless base station and to a data processor, acting as a RFID reader.

12. A wireless communication system comprising:
a ceiling grid;
an antenna distribution system with an antenna means functioning as an antenna for wireless signal propagation, said antenna means is used in conjunction with said ceiling grid and said antenna means acts as a transmission path for a wireless signal;
a wireless transmission device for transmitting said wireless signal through said transmission path; and
a wireless reception device for receiving said wireless signal from said transmission path.

13. An antenna distribution system used to facilitate a transmission and reception of wireless communications signals within demised premises (indoors) comprising:
a ceiling grid;
an antenna means formed integral with said ceiling grid operably coupled to a wireless communications network; and
a transceiver connected to said antenna means.

14. The antenna distribution system of claim 13, wherein the antenna means is embedded in said ceiling grid during fabrication.

15. The antenna distribution system of claim 1, wherein said antenna means is placed with a cavity formed at the top of said ceiling grid.

16. The antenna distribution system of claim 1, wherein said antenna means is attached to a channel formed from a portion of the bottom of said ceiling grid.

17. An antenna array comprising:
a ceiling grid having at least one antenna element embedded in said ceiling grid during the fabrication of said ceiling grid to create said antenna array, wherein said antenna array facilitates transmission and reception of a plurality of wireless signals.

18. The antenna array of claim 17, wherein said antenna array is coupled to a transceiver.

19. The antenna distribution system of claim 1, wherein said antenna means is attached to the top of said ceiling grid.
